(19) United States
(12) Patent Application Publication
(10) Pub. No.: US 2025/0139519 A1
(43) Pub. Date: May 1, 2025

(54) UPTIME BOT

(71) Applicant: Rockwell Automation Technologies, Inc., Mayfield Heights, OH (US)

(72) Inventors: Krutika Kansara, Maharashtra (IN); Francisco P. Maturana, Lyndhurst, OH (US); Shahrukh Khan, Dehli (IN); Kiran Tavadare, Pune (IN); Rahul Swami, Pune (IN); Pratyush Rout, Pune (IN)

(21) Appl. No.: 18/911,497

(22) Filed: Oct. 10, 2024

Related U.S. Application Data
(60) Provisional application No. 63/595,021, filed on Nov. 1, 2023.

(51) Int. Cl. G06N 20/00

(52) U.S. Cl. CPC G06N 20/00

(57) ABSTRACT

An industrial alarm monitoring system leverages generative artificial intelligence (AI) to perform dynamic monitoring and analysis of a customer's industrial processes, identify potential or active performance issues or alarm conditions, and assist users in resolving these issues. The system monitors and collects operational and status data from industrial devices and assets of industrial automation systems and stores information regarding active and historical alarm conditions indicated by this data in an alarm repository. Users can submit natural language requests for assistance with, or information about, active or historical alarms to the system, which leverages trained custom models and a generative AI model to process these requests. The system can formulate natural language alarm resolution guidance based on analysis of the user's request, content of the custom models, responses prompted from the generative AI model, and relevant information about the alarm condition obtained from the alarm repository.

### CROSS-REFERENCE TO RELATED APPLICATIONS

This application claims priority to U.S. Provisional Patent Application Ser. No. 63/595,021, filed on Nov. 1, 2023, and entitled “GENERATIVE AI INDUSTRIAL APPLICATIONS,” the entirety of which is incorporated herein by reference.

### TECHNICAL FIELD

The subject matter disclosed herein relates generally to industrial automation systems, and, for example, to industrial maintenance and alarm resolution.

### BACKGROUND ART

Some industrial monitoring systems, including human-machine interfaces or other types of industrial monitoring and visualization systems, are designed to identify occurrences of automation system performance issues or alarm conditions and to render alarm information that provides a broad description of the problem to be addressed. Line operators or engineers can then act on the alarm information to resolve the issue. However, alarms generated by such systems can be repetitive and redundance. Moreover, levels of experience in resolving various types of alarm conditions can vary among plant personnel, and the process of sharing knowledge among operators regarding how to address certain performance issues is reliant upon direct communication between personnel.

### BRIEF DESCRIPTION

The following presents a simplified summary in order to provide a basic understanding of some aspects described herein. This summary is not an extensive overview nor is intended to identify key/critical elements or to delineate the scope of the various aspects described herein. Its sole purpose is to present some concepts in a simplified form as a prelude to the more detailed description that is presented later.

In one or more embodiments, a system is provided, comprising a device interface component configured to store alarm data generated by devices of an industrial automation system in a cloud-based alarm repository, wherein the alarm data represents active and historical alarm conditions experienced by the industrial automation system; a user interface component configured to render a chat interface on a client device and to receive, via interaction with the chat interface, a natural language request for assistance with an alarm condition of the active and historical alarm conditions; and a generative artificial intelligence (AI) component configured to, in response to receipt of the natural language request for assistance, generate a natural language response describing a recommendation for addressing the alarm condition based on analysis of the natural language request, the alarm data, and content of one or more custom models trained with training data, wherein the user interface is configured to render the natural language response via the chat interface on the client device.

Also, one or more embodiments provide a method, comprising storing, by a system comprising a processor, alarm data generated by devices of an industrial automation system in a cloud-based alarm repository, wherein the alarm data represents active and historical alarm conditions experienced by the industrial automation system; rendering, by the system, a chat interface on a client device; receiving, by the system via interaction with the chat interface, a natural language request for assistance with an alarm condition of the active and historical alarm conditions; in response to the receiving of the natural language request, generating, by the system, a natural language response describing a recommendation for addressing the alarm condition based on analysis of the natural language request, the alarm data, and content of one or more custom models trained with training data; and rendering, by the system, the natural language response via the chat interface on the client device.

Also, according to one or more embodiments, a non-transitory computer-readable medium is provided having stored thereon instructions that, in response to execution, cause a system to perform operations, the operations comprising storing alarm data generated by devices of an industrial automation system in a cloud-based alarm repository, wherein the alarm data represents active and historical alarm conditions experienced by the industrial automation system; rendering a chat interface on a client device; receiving, via interaction with the chat interface, a natural language request for assistance with an alarm condition of the active and historical alarm conditions; in response to the receiving of the natural language request, generating a natural language response describing a recommendation for addressing the alarm condition based on analysis of the natural language request, the alarm data, and content of one or more custom models trained with training data; and rendering the natural language response via the chat interface on the client device.

To the accomplishment of the foregoing and related ends, certain illustrative aspects are described herein in connection with the following description and the annexed drawings. These aspects are indicative of various ways which can be practiced, all of which are intended to be covered herein. Other advantages and novel features may become apparent from the following detailed description when considered in conjunction with the drawings.

### BRIEF DESCRIPTION OF THE DRAWINGS

FIG. 1 is a block diagram of an example industrial control environment.

FIG. 2 is a block diagram of an example industrial alarm monitoring system.

FIG. 3 is a diagram illustrating industrial monitoring carried out by the

industrial alarm monitoring system.

FIG. 4 is a diagram illustrating training of custom models used by the system's generative AI component.

FIG. 5 is an example chat window that can be generated by the industrial alarm monitoring system based on interactions between the system and a user.

FIG. 6a is a flowchart of a first part of an example methodology for generating natural language recommendations or guidance for addressing active alarm conditions experienced by an industrial automation system.

FIG. 6b is a flowchart of a second part of the example methodology for generating natural language recommendations or guidance for addressing active alarm conditions experienced by an industrial automation system.

FIG. 7 is an example computing environment.

FIG. 8 is an example networking environment.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding thereof. It may be evident, however, that the subject disclosure can be practiced without these specific details. In other instances, well-known structures and devices are shown in block diagram form in order to facilitate a description thereof.

As used in this application, the terms “component,” “system,” “platform,” “layer,” “controller,” “terminal,” “station,” “node,” “interface” are intended to refer to a computer-related entity or an entity related to, or that is part of, an operational apparatus with one or more specific functionalities, wherein such entities can be either hardware, a combination of hardware and software, software, or software in execution. For example, a component can be, but is not limited to being, a process running on a processor, a processor, a hard disk drive, multiple storage drives (of optical or magnetic storage medium) including affixed (e.g., screwed or bolted) or removable affixed solid-state storage drives; an object; an executable; a thread of execution; a computer-executable program, and/or a computer. By way of illustration, both an application running on a server and the server can be a component. One or more components can reside within a process and/or thread of execution, and a component can be localized on one computer and/or distributed between two or more computers. Also, components as described herein can execute from various computer readable storage media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry which is operated by a software or a firmware application executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that provides at least in part the functionality of the electronic components. As further yet another example, interface(s) can include input/output (I/O) components as well as associated processor, application, or Application Programming Interface (API) components. While the foregoing examples are directed to aspects of a component, the exemplified aspects or features also apply to a system, platform, interface, layer, controller, terminal, and the like.

As used herein, the terms “to infer” and “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

In addition, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Furthermore, the term “set” as employed herein excludes the empty set; e.g., the set with no elements therein. Thus, a “set” in the subject disclosure includes one or more elements or entities. As an illustration, a set of controllers includes one or more controllers; a set of data resources includes one or more data resources; etc. Likewise, the term “group” as utilized herein refers to a collection of one or more entities; e.g., a group of nodes refers to one or more nodes.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches also can be used.

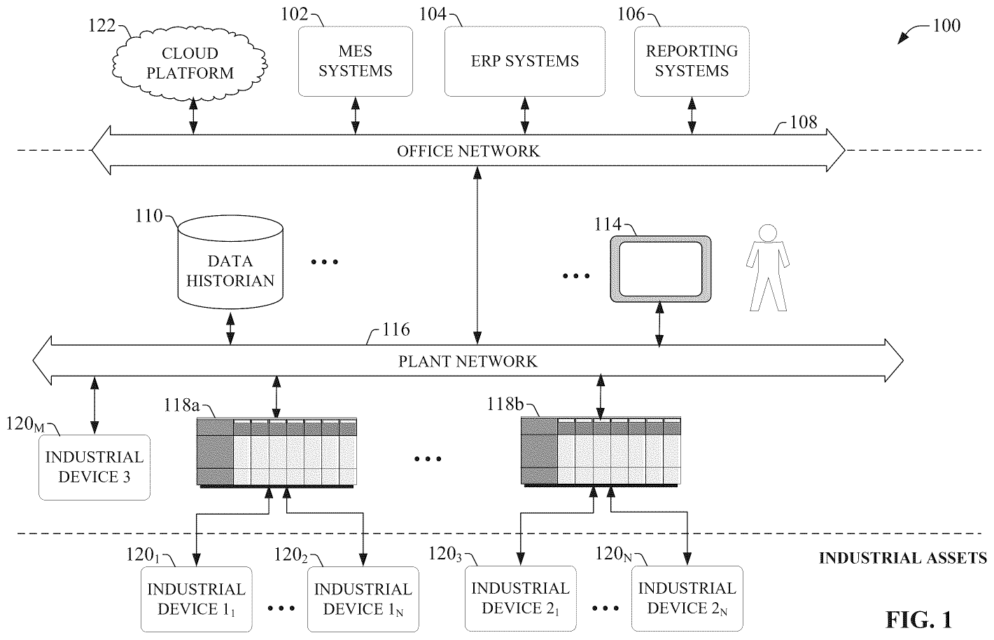

FIG. 1 is a block diagram of an example industrial control environment 100. In this example, a number of industrial controllers 118 are deployed throughout an industrial plant environment to monitor and control respective industrial systems or processes relating to product manufacture, machining, motion control, batch processing, material handling, or other such industrial functions. Industrial controllers 118 typically execute respective control programs to facilitate monitoring and control of industrial devices 120 making up the controlled industrial assets or systems (e.g., industrial machines). One or more industrial controllers 118 may also comprise a soft controller executed on a personal computer or other hardware platform, or on a cloud platform. Some hybrid devices may also combine controller functionality with other functions (e.g., visualization). The control programs executed by industrial controllers 118 can comprise any conceivable type of code used to process input signals read from the industrial devices 120 and to control output signals generated by the industrial controllers, including but not limited to ladder logic, sequential function charts, function block diagrams, or structured text.

Industrial devices 120 may include both input devices that provide data relating to the controlled industrial systems to the industrial controllers 118, and output devices that respond to control signals generated by the industrial controllers 118 to control aspects of the industrial systems. Example input devices can include telemetry devices (e.g., temperature sensors, flow meters, level sensors, pressure sensors, etc.), manual operator control devices (e.g., push buttons, selector switches, etc.), safety monitoring devices (e.g., safety mats, safety pull cords, light curtains, etc.), and other such devices. Output devices may include motor drives, pneumatic actuators, signaling devices, robot control inputs, valves, and the like. Some industrial devices, such as industrial device 120M, may operate autonomously on the plant network 116 without being controlled by an industrial controller 118.

Industrial controllers 118 may communicatively interface with industrial devices 120 over hardwired or networked connections. For example, industrial controllers 118 can be equipped with native hardwired inputs and outputs that communicate with the industrial devices 120 to effect control of the devices. The native controller I/O can include digital I/O that transmits and receives discrete voltage signals to and from the field devices, or analog I/O that transmits and receives analog voltage or current signals to and from the devices. The controller I/O can communicate with a controller's processor over a backplane such that the digital and analog signals can be read into and controlled by the control programs. Industrial controllers 118 can also communicate with industrial devices 120 over the plant network 116 using, for example, a communication module or an integrated networking port. Exemplary networks can include the Internet, intranets, Ethernet, DeviceNet, ControlNet, Data Highway and Data Highway Plus (DH/DH+), Remote I/O, Fieldbus, Modbus, Profibus, wireless networks, serial protocols, and the like. The industrial controllers 118 can also store persisted data values that can be referenced by the control program and used for control decisions, including but not limited to measured or calculated values representing operational states of a controlled machine or process (e.g., tank levels, positions, alarms, etc.) or captured time series data that is collected during operation of the automation system (e.g., status information for multiple points in time, diagnostic occurrences, etc.). Similarly, some intelligent devices—including but not limited to motor drives, instruments, or condition monitoring modules—may store data values that are used for control and/or to visualize states of operation. Such devices may also capture time-series data or events on a log for later retrieval and viewing.

Industrial automation systems often include one or more human-machine interface (HMIs) terminals 114 that allow plant personnel to view telemetry and status data associated with the automation systems, and to control some aspects of system operation. HMI terminals 114 may communicate with one or more of the industrial controllers 118 over a plant network 116, and exchange data with the industrial controllers to facilitate visualization of information relating to the controlled industrial processes on one or more pre-developed operator interface screens. HMI terminals 114 can also be configured to allow operators to submit data to specified data tags or memory addresses of the industrial controllers 118, thereby providing a means for operators to issue commands to the controlled systems (e.g., cycle start commands, device actuation commands, etc.), to modify setpoint values, etc. HMI terminals 114 execute HMI runtime applications that generate one or more display screens through which the operator interacts with the industrial controllers 118, and thereby with the controlled processes and systems. Example display screens can visualize present states of industrial systems or their associated devices using graphical representations of the processes that display metered or calculated values, employ color or position animations based on state, render alarm notifications, or employ other such techniques for presenting relevant data to the operator. Data presented in this manner is read from industrial controllers 118 by HMI terminals 114 and presented on one or more of the display screens according to display formats chosen by the HMI developer. HMI terminals 114s may comprise fixed location or mobile devices with either user-installed or pre-installed operating systems, and either user-installed or pre-installed graphical application software.

Some industrial environments may also include other systems or devices relating to specific aspects of the controlled industrial systems. These may include, for example, one or more data historians 110 that aggregate and store production information collected from the industrial controllers 118 and other industrial devices.

Industrial devices 120, industrial controllers 118, HMI terminals 114, associated controlled industrial assets, and other plant-floor systems such as data historians 110, vision systems, and other such systems operate on the operational technology (OT) level of the industrial environment. Higher level analytic and reporting systems may operate at the higher enterprise level of the industrial environment in the information technology (IT) domain; e.g., on an office network 108 or on a cloud platform 122. These higher level systems can include, for example, enterprise resource planning (ERP) systems 104 that integrate and collectively manage high-level business operations, such as finance, sales, order management, marketing, human resources, or other such business functions. Manufacturing Execution Systems (MES) 102 can monitor and manage control operations on the control level in view of higher-level business considerations, driving those control-level operations toward outcomes that satisfy defined business goals (e.g., order fulfillment, resource tracking and management, asset utilization tracking, etc.). Reporting systems 106 can collect operational data from industrial devices on the plant floor and generate daily or shift reports that summarize operational statistics of the controlled industrial assets.

Some industrial monitoring systems, including human-machine interfaces or other types of industrial monitoring and visualization systems, are designed to identify occurrences of automation system performance issues or alarm conditions and to render alarm information that provides a broad description of the problem to be addressed. Line operators or engineers can then act on the alarm information to resolve the issue. However, alarms generated by such systems can be repetitive and redundance. Moreover, levels of experience in resolving various types of alarm conditions can vary among plant personnel, and the process of sharing knowledge among operators regarding how to address certain performance issues is reliant upon direct communication between personnel.

To address these and other issues, one or more embodiments described herein provide an industrial alarm monitoring system that leverages generative AI to perform dynamic monitoring and analysis of a customer's industrial processes, identify potential or active performance issues or alarm conditions, and assist users in resolving these issues. The system monitors and collects operational and status data from industrial devices and assets of industrial automation systems and stores information regarding active and historical alarm conditions indicated by this data in an alarm repository. Users can submit natural language requests for assistance with, or information about, active or historical alarms to the system, which leverages trained custom models and a generative AI model to process these requests. The system can formulate natural language alarm resolution guidance based on analysis of the user's request, content of the custom models, responses prompted from the generative AI model, and relevant information about the alarm condition obtained from the alarm repository

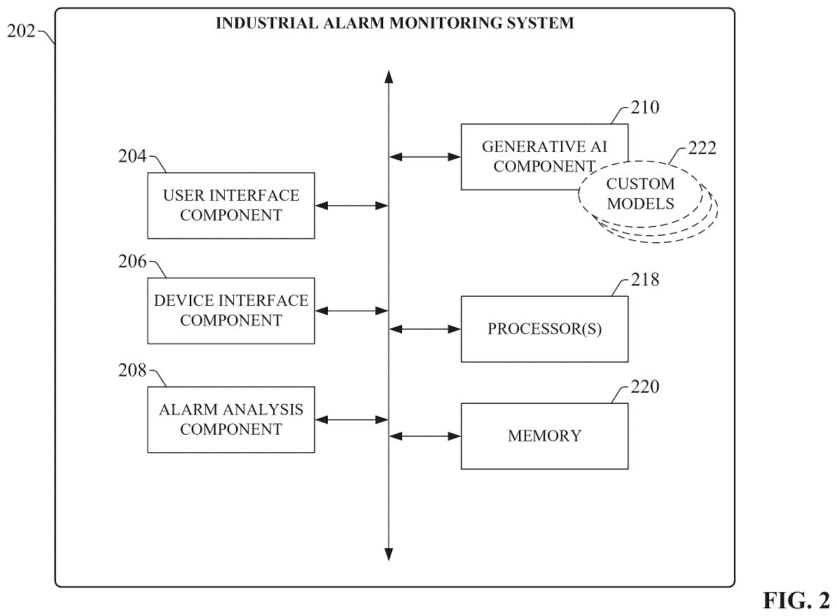

FIG. 2 is a block diagram of an example industrial alarm monitoring system 202 according to one or more embodiments of this disclosure. Aspects of the systems, apparatuses, or processes explained in this disclosure can constitute machine-executable components embodied within machine(s), e.g., embodied in one or more computer-readable mediums (or media) associated with one or more machines. Such components, when executed by one or more machines, e.g., computer(s), computing device(s), automation device(s), virtual machine(s), etc., can cause the machine(s) to perform the operations described.

Industrial alarm monitoring system 202 can include a user interface component 204, a device interface component 206, an alarm analysis component 208, a generative AI component 210, one or more processors 218, and memory 220. In various embodiments, one or more of the user interface component 204, device interface component 206, alarm analysis component 208, generative AI component 210, the one or more processors 218, and memory 220 can be electrically and/or communicatively coupled to one another to perform one or more of the functions of the industrial alarm monitoring system 202. In some embodiments, components 204, 206, 208, and 210 can comprise software instructions stored on memory 220 and executed by processor(s) 218. Industrial alarm monitoring system 202 may also interact with other hardware and/or software components not depicted in FIG. 2. For example, processor(s) 218 may interact with one or more external user interface devices, such as a keyboard, a mouse, a display monitor, a touchscreen, or other such interface devices.

User interface component 204 can be configured to receive user input and to render output to the user in any suitable format (e.g., visual, audio, tactile, etc.). In some embodiments, user interface component 204 can be configured to generate and serve interface displays, such as chat interface displays, to a client device, and exchange data via these interface displays. Input data that can be received via various embodiments of user interface component 204 can include, but is not limited to, natural language request for assistance with, or information about, active or historical alarm conditions experienced by an industrial automation system. Output data rendered by various embodiments of user interface component 204 can include, but is not limited to, natural language chat interfaces, responses to requests for assistance with active or historical alarm conditions, or other such output data.

Device interface component 206 can be configured to receive data generated by industrial devices associated with an industrial automation system (e.g., industrial controllers 118 or other industrial devices) during operation of the automation system. Device interface component 206 can retrieve this data from various data sources, including the industrial devices themselves, controller emulators, repositories of archived historical data, or other such sources.

Alarm analysis component 208 can be configured to analyze stored historical data to determine answers to natural language queries submitted via the user interface component 204, or to determine possible resolutions to automation system performance problems posed via natural language submissions. Generative AI component 210 can be configured to assist the alarm analysis component 208 in parsing a user's natural language query and analyzing the historical data using generative AI. To the end, the generative AI component 210 can implement prompt engineering functionality using associated custom models 222 trained with domain-specific industrial training data, using these models 222 to generate and submit prompts to a generative AI model and associated neural networks in connection with analyzing users' natural language requests or queries regarding active or historical alarm conditions and formulating natural language responses having a high probability of addressing these requests and queries.

The one or more processors 218 can perform one or more of the functions described herein with reference to the systems and/or methods disclosed. Memory 220 can be a computer-readable storage medium storing computer-executable instructions and/or information for performing the functions described herein with reference to the systems and/or methods disclosed.

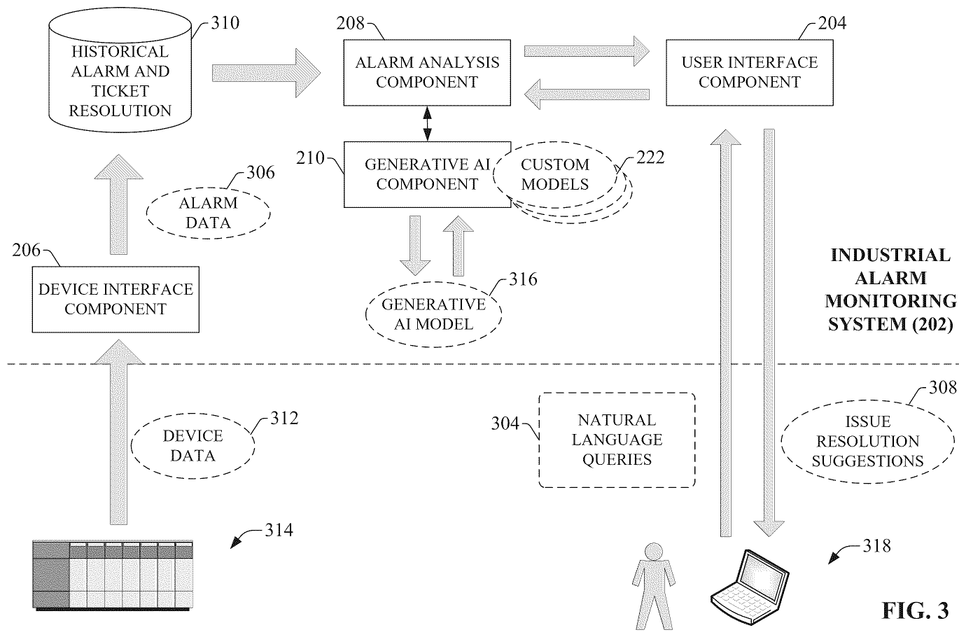

FIG. 3 is a diagram illustrating industrial monitoring carried out by the system 202 according to one or more embodiments. Some embodiments of the industrial alarm monitoring system 202 can be implemented on a cloud platform and made accessible to multiple industrial customers having authorized access to use the system's services. Alternatively, some embodiments of industrial alarm monitoring system 202 may execute at least partially on a local client device while accessing remote services and repositories as needed.

In general, when an industrial automation system or its associated controlled process experiences an abnormal condition, traditional alarm systems, such as those that are integrated into the automation system's HMI, are limited in their ability to assist with root cause analysis, since these alarm systems require a priori knowledge of the automation system's components and construction—e.g., moving parts of the automation system's machinery, control devices that monitor or control the automation system, the type of industrial application carried out by the automation system, etc.—at the time that the alarm definitions are configured. This can limit an alarm system's ability to provide useful diagnostic information about unexpected ad hoc performance problems experienced by the automation system and to extract insights about these conditions from available data.

To address these and other issues, industrial alarm monitoring system 202 can perform analysis on historical alarm data 306 generated by a customer's automation system, as well as live and historical device data 312 generated by the industrial devices 314 that monitor and control the automation system, and render results of this analysis via a chat interface rendered on a client device 318 (e.g., a mobile smart phone, a laptop computer, a tablet computer, a desktop computer, etc.) or on an HMI terminal that visualizes operational and status information for the automation system. This analysis can be performed by the generative AI component 210, which analyzes collected device data 312 and historical alarm data 306 based on industrial knowledge encoded in the custom models 322 as well as responses 506 prompted from a generative AI model 316. The system 202 can use this type of analysis to identify trends or patterns in the historical device data 312 indicative of a future or predicted performance issue with an industrial device or automation system, predicted failure of an industrial device 314 or mechanical component of the automation system, or other such issues. Using this and other types of analysis, system 202 can serve as an industrial monitoring system capable of performing dynamic monitoring and analysis of a customer's industrial processes, identifying potential or active performance issues or alarm conditions, and assisting users in resolving these issues.

In some embodiments, the system 202 can be implemented as an internet-of-things (IoT) monitoring and alert system designed for manufacturing plants and customer sites. The system's device interface component 206 can monitor device data 312 generated by industrial devices 314 (e.g., industrial controllers, motor drives, vision systems, safety relays, sensors, etc.) during operation of their associated automation systems, and store alarm data 306 derived from this device data 312 in a cloud-based historical alarm repository 310 or database. To obtain the device data 312, the system's device interface component 206 can be configured to connect to various types of data sources across a range of communication protocols, including industrial controllers 118 (from which the device interface component 206 can obtain data determined to be relevant to the user's query from the appropriate data tags), digital and analog sensors (e.g., proximity switches, telemetry devices, meters, etc.), variable frequency drives, open platform communications unified architecture (OPCUA) devices, MQ telemetry transport (MQTT) devices, or other such devices and protocols

Alarm data 306 comprises information about detected abnormal conditions indicated by the device data 312. This alarm data 306 can comprise, for example, a description of the alarm conditions; a date and time at which the alarm condition was initiated; an industrial device, machine, or asset from which the alarm condition originated, or other such information. Example alarm conditions that can be recorded as alarm data 306 can include, but are not limited to, values of key performance indicators (KPIs) moving outside defined high or low limits for those KPIs (e.g., temperatures, pressures, levels, speeds, etc.), memory usage warnings for industrial devices that require data storage capacity, machine downtime conditions or abnormal status indicators, communication errors experienced by networked industrial devices, or other such alarms.

The repository 310 can also store resolution data describing steps or actions taken by maintenance personnel to resolve previous alarm conditions. To this end, some embodiments of the system 202 can allow maintenance personnel or line operators to submit information describing actions taken to resolve a specific alarm condition experienced by an automation system. In an example embodiment, this information can be submitted as a natural language description via a chat interface rendered by the system's user interface component 204. This natural language description can indicate steps or actions taken to address the issue represented by the alarm. The generative AI component 210 can translate this natural language submission into resolution data and store this resolution data in the repository 310 for future reference in connection with addressing a similar alarm condition. Alarm resolution information can also be submitted via other means in various embodiments.

Conventionally, alarms generated by industrial devices 314 or their associated monitoring systems can be repetitive, and historical data describing resolution steps is seldom used. When an alarm condition requiring corrective action from an operator or maintenance technician occurs, personnel must typically perform multiple debugging steps, in some cases on a trial-and-error basis, to reach a solution. To address these issues, the generative AI component 210 of system 202 can implement an intelligent chatbot or chat interface that aids in resolution of automation system performance issues. Maintenance technicians and engineers can interact with the chatbot by submitting natural language queries 304 via the user interface component 204 asking for assistance with resolving an active alarm condition, or requesting specific information about an active or past alarm condition. The alarm analysis component 208, together with the generative AI component 210 and its associated custom models 222, can leverage the historical data stored in the historical alarm repository 310—including historical and current alarm data 306 and any historical resolution data associated with respective types of alarms—to provide relevant recommendations and suggestions 308, which can be presented via the chat interface on the user's client device 318 as natural language responses.

The user's natural language query 304 can articulate the type of information being requested relative to a given alarm condition—either an active or historical alarm—using any type of natural language formulation. For example, the query 304 can specify the alarm condition of interest by describing one or both of the alarm condition or the machine or device that is affected by the alarm condition (or from which the alarm condition originated). The query 304 can also articulate the nature of the information the user wishes to obtain relative to the indicated alarm, which can include, but is not limited to, suggested actions to be taken that are likely to resolve the alarm condition, (e.g., “Can you suggest a resolution?”), statistical information about the alarm condition (“How often does this alarm occur?”, “What is the average downtime caused by this alarm?”, etc.), predicted effects of the alarm condition (e.g., “Arc other machines likely to be affected by this alarm condition?”, “How long will it take to fix this problem?”, etc.), or other such information.

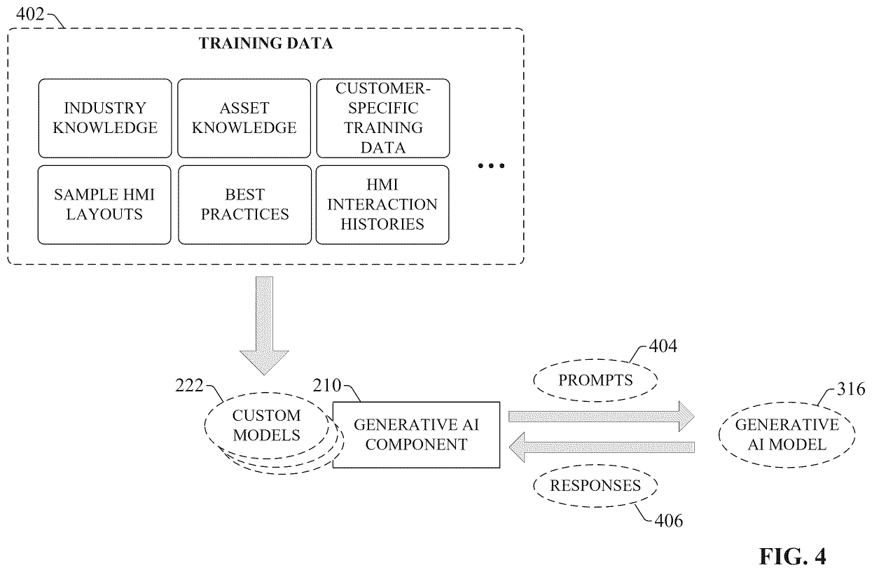

As noted above, industrial alarm monitoring system 202 can leverage generative AI to assist with alarm condition resolution. To this end, the system's generative AI component 210 can implement prompt engineering functionality using associated custom models 222 trained with domain-specific industrial training data, and can interface with a generative AI model 316 (e.g., a large language model or another type of model) and associated neural networks. FIG. 4 is a diagram illustrating training of the custom models 222 used by the generative AI component 210. In some embodiments, the generative AI model 316 can reside and execute externally from the system 202, and the generative AI component 210 can include suitable connectivity tools and protocols, application programming interfaces (APIs), or other such services that allow the generative AI component 210 to exchange prompts and responses with the generative AI model 316. Custom models 222 can be trained using sets of training data 402 representing a range of domain-specific industrial knowledge, as well as customer-specific knowledge, that can assist the generative AI component 210 generating issue resolution suggestions 308 having a high probability of addressing a user's questions regarding automation system alarm conditions or performance issues, as conveyed via natural language queries 304.

Example training data 402 that can be used to train the custom models 222 includes, but is not limited to, information defining industrial standards (e.g., global or vertical-specific safety standards, food and drug standards, design standards such as the ISA-88 standard, etc.), technical specifics or design standards for various types of industrial control applications (e.g., batch control processes, die casting, valve control, agitator control, etc.), knowledge of specific industrial verticals (e.g., automotive, food and beverage, pharmaceuticals, oil and gas, textiles, mining, etc.), knowledge of industrial best practices, technical specifications for various types of industrial devices or assets (e.g., industrial controllers, motor drives such as variable frequency drives, sensors, etc.), control design rules, customer-specific information regarding plant locations operated by the customer and the industrial systems in service at the respective locations, or other such training data.

When a natural language query 304 (see FIG. 3) requesting assistance with a specified alarm condition is received, the generative AI component 210 can, as needed, formulate and submit prompts 404 to the generative AI model 316 designed to obtain responses 406 that assist the alarm analysis component 208 to generate a natural language resolution suggestion 308 that satisfies the criteria specified by the user's query 304 (that is, to generate a suggestion 308 determined to have a probability of satisfying the user's query 304 that exceeds a defined probability level). These prompts 404 are generated based on content of the user's natural language query 304 as well as the industry knowledge and reference data encoded in the trained custom models 222. The generative AI component 210 can reference custom models 222 as needed in connection with processing a user's natural language queries 304 and prompting the generative AI model 316 for responses 406 that assist the alarm analysis component 208 in processing these queries. The generative AI component 210 can generate the prompt 404 to include at least one of information extracted or inferred from the natural language query 304, an identity of an industrial asset affected by the alarm condition, a description of the alarm condition, a type of industrial application being performed by the industrial automation system, an industrial vertical in which the industrial automation system operates, or a selected subset of the content of the custom models 222.

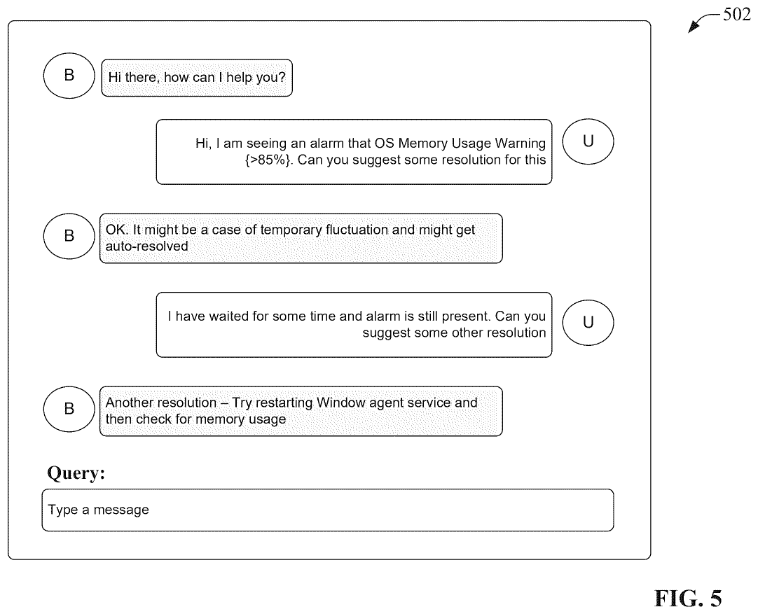

Returning to FIG. 3, in an example scenario, the user can submit a natural language query 304 to the chat interface rendered by user interface component 204 asking for suggestions for resolving a problem indicated by an active alarm recorded in the repository 310 (e.g., “Can you suggest a resolution for the Alarm saying Host CPU Usage Critical [>85%]?”). In response, the alarm analysis component 208 can analyze the data stored in the historical alarm data repository 310—guided by the generative AI component 210, its associated custom models 222, and responses 406 prompted from the generative AI model 316 (see FIG. 4)—to infer a possible solution to the issue indicated by the natural language query 304, and can generate a natural language response describing the solution. This natural language response is then rendered on the chat interface by the user interface component 204 as an issue resolution suggestion 308. If the alarm analysis component 208 determines that the issue may resolve itself without intervention by the user, the user interface component 204 may indicate this in the suggestion 308 (e.g., “OK. It might be a case of temporary fluctuation and might get auto-resolved.”). The user may provide a subsequent response indicating that the problem has not resolved (e.g., “I have waited for some time and alarm is still present. Can you suggest some other resolution?”). In response, the system 202 can further analyze the historical data—e.g., resolution data stored in the repository 310, archived device data 312 collected from different industrial devices, etc.—and offer a more active course of action (e.g., “Another resolution—try restarting Window agent service and then check for memory usage.”). FIG. 5 is an example chat window 502 that can be generated by the user interface component 204, based on interactions between the system 202 and the user. The use of generative AI to assist plant personal in addressing alarm conditions can reduce the time required to resolve alarms, improving productivity. The industrial alarm monitoring system 202 described herein can assist users with data-driven decision-making by using generative AI to glean insights from real-time and historical data generated by the customer's automation systems.

Although the industrial alarm monitoring system 202 has been depicted herein as residing and executing on a cloud platform for remote access by customers, other architectures can be used to deploy and execute the system 202. For example, the system 202 may be deployed in a hybrid architecture in which the user interface component 204, device interface component 206, generative AI component 210, and alarm analysis component 208 execute on-premise at the customer's facility, while the generative AI model 316 executes on a cloud platform. In such deployment architectures, the system 202 can remotely access the generative AI model 316 from the customer facility, exchanging prompts 404 and responses 406 with the generative AI model 316 as needed to process a user's natural language queries 304. According to another example deployment architecture, the system 202 can be deployed as a purely on-premise solution in which the system 202 and generative AI model 316 execute on systems that operate at the customer's facility or on one or more edge-level devices.

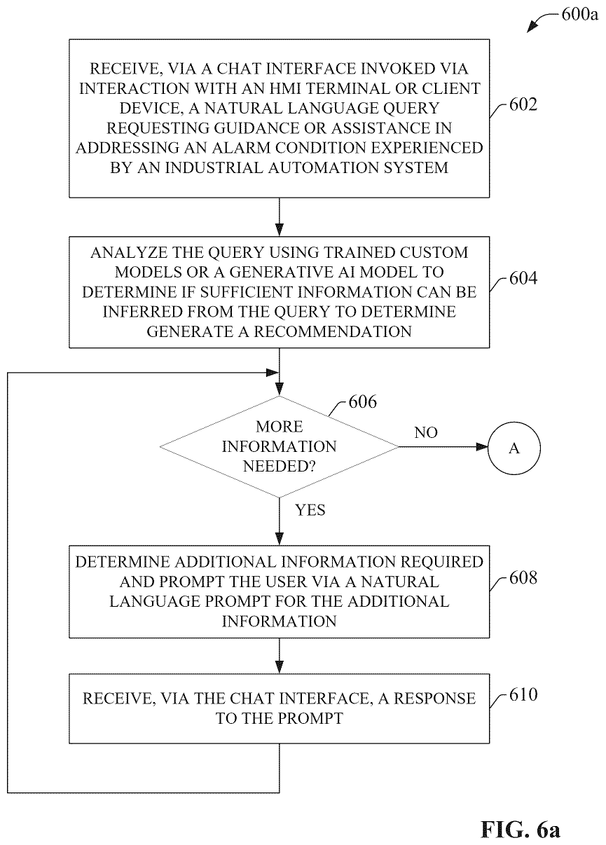

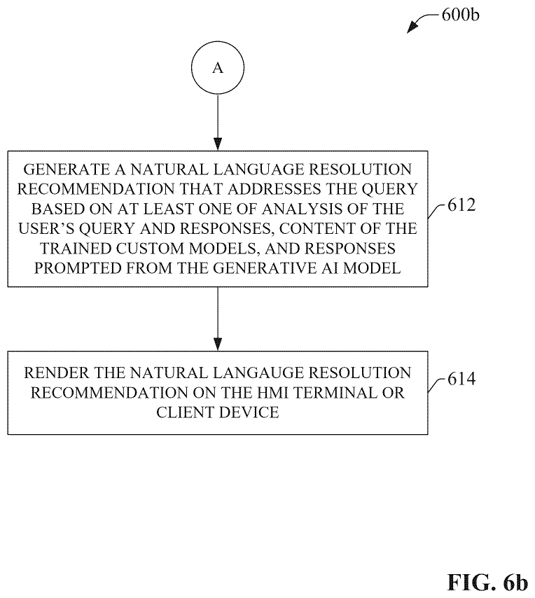

FIGS. 6b-6b illustrate a methodology in accordance with one or more embodiments of the subject application. While, for purposes of simplicity of explanation, the methodology shown herein are shown and described as a series of acts, it is to be understood and appreciated that the subject innovation is not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation. Furthermore, interaction diagram(s) may represent methodologies, or methods, in accordance with the subject disclosure when disparate entities enact disparate portions of the methodologies. Further yet, two or more of the disclosed example methods can be implemented in combination with each other, to accomplish one or more features or advantages described herein.

FIG. 6a illustrates a first part of an example methodology 600a for generating natural language recommendations or guidance for addressing active alarm conditions experienced by an industrial automation system. Initially, at 902, a natural language query describing a requesting guidance or assistance in addressing an alarm condition experienced by an industrial automation system is received via a chat interface or another type of natural language interface supported by an industrial alarm monitoring system. The chat interface can be invoked via an interaction with an HMI terminal device or a client device that remotely interfaces with the industrial alarm monitoring system. The natural language query can identify the alarm condition for which information or guidance is desired by describing, using natural language typed or spoken input, the alarm condition itself, the machine or device that is experiencing the alarm condition, or other information that can be used by the system to identify the alarm. The query 304 can also specify the type of information the user wishes to obtain, including but not limited to a guidance in resolving the alarm, historical statistics for the alarm (e.g., a frequency of occurrence, an accumulated or average amount of machine downtime caused by the alarm condition, etc.), additional contextual information about the consequences of the alarm condition (e.g., a request for identities of other machines that may experience performance issues as a result of the alarm condition), or other such information.

At 604, the request received at step 602 is analyzed by the industrial alarm monitoring system using trained custom models or a generative AI to determine if sufficient information can be inferred from the query to generate a response having a sufficiently high probability of satisfactorily addressing query. The custom models can be trained using sets of training data representing a range of domain-specific industrial knowledge. Example training data that can be used to train the custom models includes, but is not limited to, information defining industrial standards (e.g., global or vertical-specific safety standards, food and drug standards, design standards such as the ISA-88 standard, etc.), technical specifics or design standards for various types of industrial control applications (e.g., batch control processes, die casting, valve control, agitator control, etc.), knowledge of specific industrial verticals (e.g., automotive, food and beverage, pharmaceuticals, oil and gas, textiles, mining, etc.), knowledge of industrial best practices, technical specifications for various types of industrial devices or assets (e.g., industrial controllers, motor drives such as variable frequency drives, sensors, etc.), control design rules, or other such training data. As part of the analysis, the system can also generate and submit prompts to the generative AI model and use the content of the generative AI model's responses in connection with analyzing the user's request and generating natural languages responses directed to the user if necessary.

At 606, a determination is made as to whether more information is needed from the user in order to determine the nature of the user's query and generate a suitable response determined to satisfy these requirements. If additional information is required (YES at step 606), the methodology proceeds to step 608, where the system determines the additional information required, and renders a natural language prompt designed to guide the user toward providing the additional information. In determining the nature of the necessary additional information, the system can reference the industry knowledge encoded in the trained models as well as responses prompted from the generative AI model. At 610, a response to the prompt generated at step 608 is received via the chat interface.

Steps 606-610 are repeated as a natural language dialog with the user until sufficient information translatable to a response to the initial query has been obtained. When no further information is required from the user (NO at step 606), the methodology proceeds to the second part 600b illustrated in FIG. 6b. At 612, the industrial alarm monitoring system generates a natural language resolution recommendation determined to address the query received at step 602 based on at least one of analysis of the user's natural language query and responses as obtained at step 610, content of the trained custom models, or responses prompted from the generative AI model. At 614, the natural language resolution generated at step 612 is rendered on the HMI terminal or client device.

Embodiments, systems, and components described herein, as well as control systems and automation environments in which various aspects set forth in the subject specification can be carried out, can include computer or network components such as servers, clients, programmable logic controllers (PLCs), automation controllers, communications modules, mobile computers, on-board computers for mobile vehicles, wireless components, control components and so forth which are capable of interacting across a network. Computers and servers include one or more processors—electronic integrated circuits that perform logic operations employing electric signals—configured to execute instructions stored in media such as random access memory (RAM), read only memory (ROM), a hard drives, as well as removable memory devices, which can include memory sticks, memory cards, flash drives, external hard drives, and so on.

Similarly, the term PLC or automation controller as used herein can include functionality that can be shared across multiple components, systems, and/or networks. As an example, one or more PLCs or automation controllers can communicate and cooperate with various network devices across the network. This can include substantially any type of control, communications module, computer, Input/Output (I/O) device, sensor, actuator, and human machine interface (HMI) that communicate via the network, which includes control, automation, and/or public networks. The PLC or automation controller can also communicate to and control various other devices such as standard or safety-rated I/O modules including analog, digital, programmed/intelligent I/O modules, other programmable controllers, communications modules, sensors, actuators, output devices, and the like.

The network can include public networks such as the internet, intranets, and automation networks such as control and information protocol (CIP) networks including DeviceNet, ControlNet, safety networks, and Ethernet/IP. Other networks include Ethernet, DH/DH+, Remote I/O, Fieldbus, Modbus, Profibus, CAN, wireless networks, serial protocols, and so forth. In addition, the network devices can include various possibilities (hardware and/or software components). These include components such as switches with virtual local area network (VLAN) capability, LANs, WANs, proxies, gateways, routers, firewalls, virtual private network (VPN) devices, servers, clients, computers, configuration tools, monitoring tools, and/or other devices.

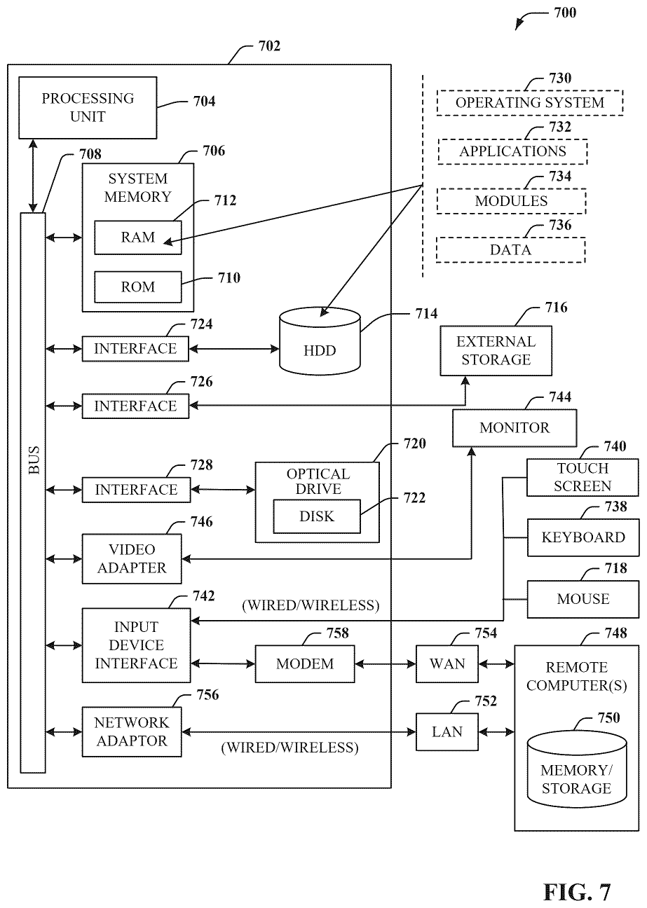

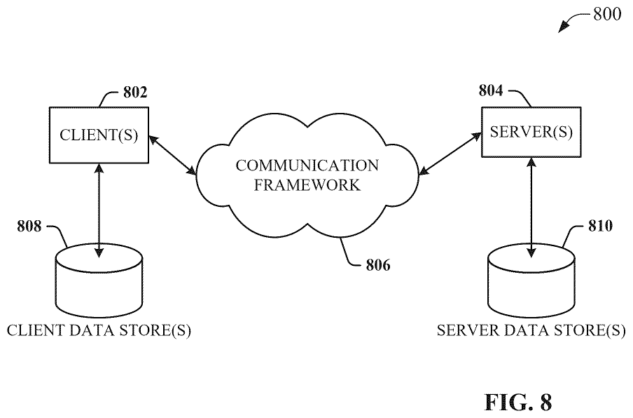

In order to provide a context for the various aspects of the disclosed subject matter, FIGS. 7 and 8 as well as the following discussion are intended to provide a brief, general description of a suitable environment in which the various aspects of the disclosed subject matter may be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 7, the example environment 700 for implementing various embodiments of the aspects described herein includes a computer 702, the computer 702 including a processing unit 704, a system memory 706 and a system bus 708. The system bus 708 couples system components including, but not limited to, the system memory 706 to the processing unit 704. The processing unit 704 can be any of various commercially available processors. Dual microprocessors and other multi-processor architectures can also be employed as the processing unit 704.

The system bus 708 can be any of several types of bus structure that can further interconnect to a memory bus (with or without a memory controller), a peripheral bus, and a local bus using any of a variety of commercially available bus architectures. The system memory 706 includes ROM 710 and RAM 712. A basic input/output system (BIOS) can be stored in a non-volatile memory such as ROM, erasable programmable read only memory (EPROM), EEPROM, which BIOS contains the basic routines that help to transfer information between elements within the computer 702, such as during startup. The RAM 712 can also include a high-speed RAM such as static RAM for caching data.

The computer 702 further includes an internal hard disk drive (HDD) 714 (e.g., EIDE, SATA), one or more external storage devices 716 (e.g., a magnetic floppy disk drive (FDD) 716, a memory stick or flash drive reader, a memory card reader, etc.) and an optical disk drive 720 (e.g., which can read or write from a CD-ROM disc, a DVD, a BD, etc.). While the internal HDD 714 is illustrated as located within the computer 702, the internal HDD 714 can also be configured for external use in a suitable chassis (not shown). Additionally, while not shown in environment 700, a solid state drive (SSD) could be used in addition to, or in place of, an HDD 714. The HDD 714, external storage device(s) 716 and optical disk drive 720 can be connected to the system bus 708 by an HDD interface 724, an external storage interface 726 and an optical drive interface 728, respectively. The interface 724 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 702, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 712, including an operating system 730, one or more application programs 732, other program modules 734 and program data 736. All or portions of the operating system, applications, modules, and/or data can also be cached in the RAM 712. The systems and methods described herein can be implemented utilizing various commercially available operating systems or combinations of operating systems.

Computer 702 can optionally comprise emulation technologies. For example, a hypervisor (not shown) or other intermediary can emulate a hardware environment for operating system 730, and the emulated hardware can optionally be different from the hardware illustrated in FIG. 7. In such an embodiment, operating system 730 can comprise one virtual machine (VM) of multiple VMs hosted at computer 702. Furthermore, operating system 730 can provide runtime environments, such as the Java runtime environment or the. NET framework, for application programs 732. Runtime environments are consistent execution environments that allow application programs 732 to run on any operating system that includes the runtime environment. Similarly, operating system 730 can support containers, and application programs 732 can be in the form of containers, which are lightweight, standalone, executable packages of software that include, e.g., code, runtime, system tools, system libraries and settings for an application.

Further, computer 702 can be enable with a security module, such as a trusted processing module (TPM). For instance with a TPM, boot components hash next in time boot components, and wait for a match of results to secured values, before loading a next boot component. This process can take place at any layer in the code execution stack of computer 702, e.g., applied at the application execution level or at the operating system (OS) kernel level, thereby enabling security at any level of code execution.

A user can enter commands and information into the computer 702 through one or more wired/wireless input devices, e.g., a keyboard 738, a touch screen 740, and a pointing device, such as a mouse 718. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 704 through an input device interface 744 that can be coupled to the system bus 708, but can be connected by other interfaces, such as a parallel port, an IEEE 1394 serial port, a game port, a USB port, an IR interface, a BLUETOOTH® interface, etc.

A monitor 744 or other type of display device can be also connected to the system bus 708 via an interface, such as a video adapter 746. In addition to the monitor 744, a computer typically includes other peripheral output devices (not shown), such as speakers, printers, etc.

The computer 702 can operate in a networked environment using logical connections via wired and/or wireless communications to one or more remote computers, such as a remote computer(s) 748. The remote computer(s) 748 can be a workstation, a server computer, a router, a personal computer, portable computer, microprocessor-based entertainment appliance, a peer device or other common network node, and typically includes many or all of the elements described relative to the computer 702, although, for purposes of brevity, only a memory/storage device 750 is illustrated. The logical connections depicted include wired/wireless connectivity to a local area network (LAN) 752 and/or larger networks, e.g., a wide area network (WAN) 754. Such LAN and WAN networking environments are commonplace in offices and companies, and facilitate enterprise-wide computer networks, such as intranets, all of which can connect to a global communications network, e.g., the Internet.

When used in a LAN networking environment, the computer 702 can be connected to the local network 752 through a wired and/or wireless communication network interface or adapter 756. The adapter 756 can facilitate wired or wireless communication to the LAN 752, which can also include a wireless access point (AP) disposed thereon for communicating with the adapter 756 in a wireless mode.

When used in a WAN networking environment, the computer 702 can include a modem 758 or can be connected to a communications server on the WAN 754 via other means for establishing communications over the WAN 754, such as by way of the Internet.

The modem 758, which can be internal or external and a wired or wireless device, can be connected to the system bus 708 via the input device interface 742. In a networked environment, program modules depicted relative to the computer 702 or portions thereof, can be stored in the remote memory/storage device 750. It will be appreciated that the network connections shown are example and other means of establishing a communications link between the computers can be used.

When used in either a LAN or WAN networking environment, the computer 702 can access cloud storage systems or other network-based storage systems in addition to, or in place of, external storage devices 716 as described above. Generally, a connection between the computer 702 and a cloud storage system can be established over a LAN 752 or WAN 754 e.g., by the adapter 756 or modem 758, respectively. Upon connecting the computer 702 to an associated cloud storage system, the external storage interface 726 can, with the aid of the adapter 756 and/or modem 758, manage storage provided by the cloud storage system as it would other types of external storage. For instance, the external storage interface 726 can be configured to provide access to cloud storage sources as if those sources were physically connected to the computer 702.

The computer 702 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

FIG. 8 is a schematic block diagram of a sample computing environment 800 with which the disclosed subject matter can interact. The sample computing environment 800 includes one or more client(s) 802. The client(s) 802 can be hardware and/or software (e.g., threads, processes, computing devices). The sample computing environment 800 also includes one or more server(s) 804. The server(s) 804 can also be hardware and/or software (e.g., threads, processes, computing devices). The servers 804 can house threads to perform transformations by employing one or more embodiments as described herein, for example.

One possible communication between a client 802 and servers 804 can be in the form of a data packet adapted to be transmitted between two or more computer processes. The sample computing environment 800 includes a communication framework 806 that can be employed to facilitate communications between the client(s) 802 and the server(s) 804. The client(s) 802 are operably connected to one or more client data store(s) 808 that can be employed to store information local to the client(s) 802. Similarly, the server(s) 804 are operably connected to one or more server data store(s) 810 that can be employed to store information local to the servers 804.

What has been described above includes examples of the subject innovation. It is, of course, not possible to describe every conceivable combination of components or methodologies for purposes of describing the disclosed subject matter, but one of ordinary skill in the art may recognize that many further combinations and permutations of the subject innovation are possible. Accordingly, the disclosed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the disclosed subject matter. In this regard, it will also be recognized that the disclosed subject matter includes a system as well as a computer-readable medium having computer-executable instructions for performing the acts and/or events of the various methods of the disclosed subject matter.

In addition, while a particular feature of the disclosed subject matter may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

In this application, the word “exemplary” is used to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Various aspects or features described herein may be implemented as a method, apparatus, or article of manufacture using standard programming and/or engineering techniques. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks [e.g., compact disk (CD), digital versatile disk (DVD) . . . ], smart cards, and flash memory devices (e.g., card, stick, key drive . . . ).

What is claimed is:

1. A system, comprising:
a memory that stores executable components; and
a processor, operatively coupled to the memory, that executes the executable components, the executable components comprising:
a device interface component configured to store alarm data generated by devices of an industrial automation system in a cloud-based alarm repository, wherein the alarm data represents active and historical alarm conditions experienced by the industrial automation system;
a user interface component configured to render a chat interface on a client device and to receive, via interaction with the chat interface, a natural language request for assistance with an alarm condition of the active and historical alarm conditions; and
a generative artificial intelligence (AI) component configured to, in response to receipt of the natural language request for assistance, generate a natural language response describing a recommendation for addressing the alarm condition based on analysis of the natural language request, the alarm data, and content of one or more custom models trained with training data,
wherein the user interface is configured to render the natural language response via the chat interface on the client device.

2. The system of claim 1, wherein the training data comprises at least one of information defining industrial standards, technical specifics for respective types of industrial control applications, knowledge of respective industrial verticals, information describing industrial best practices, technical specifications for different types of industrial devices or machines, or control design rules.

3. The system of claim 1, wherein
the generative AI component is further configured to store resolution information describing steps taken by plant personnel to resolve one or more of the historical alarm conditions, and
the generative AI component is configured to generate the natural language response further based on analysis of the resolution information.

4. The system of claim 1, wherein the generative AI component is further configured to, in response to receipt of the natural language request, formulate a prompt, directed to a generative AI model, designed to obtain a response from the generative AI model comprising information used by the generative AI component to infer a response having a probability of addressing the natural language request that exceeds a defined probability level.

5. The system of claim 4, wherein the generative AI component is configured to formulate the prompt to include at least one of information extracted or inferred from the natural language request, an identity of an industrial asset affected by the alarm condition, a description of the alarm condition, a type of industrial application being performed by the industrial automation system, an industrial vertical in which the industrial automation system operates, or a selected subset of the content of the one or more custom models.

6. The system of claim 1, wherein the generative AI component is further configured to, in response to determining, based on analysis of the natural language request, that additional information will allow the generative AI component to formulate the natural language response such that the natural language response has a probability of satisfying the natural language request that exceeds a threshold, generate a natural language prompt for the additional information, render the natural language prompt via the user interface component, and formulate the natural language response based on analysis of the natural language request, the content of the one or more custom models, and the additional information.

7. The system of claim 1, wherein the natural language request describes at least one of the alarm condition, a machine or device of the industrial automation system that experiences the alarm condition, or a type of information about the alarm condition to be provided by the natural language response.

8. The system of claim 1, wherein the type of information about the alarm condition is at least one of a recommendation for resolving the alarm condition, a historical frequency at which the alarm condition occurs, indications of machines that are affected by the alarm condition, or an average machine downtime caused by the alarm condition.

9. The system of claim 1, wherein the alarm condition is at least one of a value of a key performance indicator of the industrial automation system exceeding a defined high limit, the value of the key performance indicator moving below a defined low limit, a memory usage alarm for an industrial device, a machine downtime condition, an abnormal status indicator, or a device communication error.

10. A method, comprising:
storing, by a system comprising a processor, alarm data generated by devices of an industrial automation system in a cloud-based alarm repository, wherein the alarm data represents active and historical alarm conditions experienced by the industrial automation system;
rendering, by the system, a chat interface on a client device;
receiving, by the system via interaction with the chat interface, a natural language request for assistance with an alarm condition of the active and historical alarm conditions;
in response to the receiving of the natural language request, generating, by the system, a natural language response describing a recommendation for addressing the alarm condition based on analysis of the natural language request, the alarm data, and content of one or more custom models trained with training data; and
rendering, by the system, the natural language response via the chat interface on the client device.

11. The method of claim 10, wherein the training data comprises at least one of information defining industrial standards, technical specifics for respective types of industrial control applications, knowledge of respective industrial verticals, information describing industrial best practices, technical specifications for different types of industrial devices or machines, or control design rules.

12. The method of claim 10, further comprising storing, by the system, resolution information describing actions performed by plant personnel to resolve one or more of the historical alarm conditions,
wherein the generating of the natural language response comprises generating the natural language response further based on analysis of the resolution information.

13. The method of claim 10, further comprising, in response to the receiving of the natural language request, formulating, by the system, a prompt directed to a generative AI model, wherein the prompt is designed to obtain a response from the generative AI model comprising information used by the system to infer a response to the natural language request having a probability of addressing the natural language request that exceeds a defined probability level.

14. The method of claim 13, wherein the formulating of the prompt comprises formulating the prompt to include at least one of information extracted or inferred from the natural language request, an identity of an industrial asset affected by the alarm condition, a description of the alarm condition, a type of industrial application being performed by the industrial automation system, an industrial vertical in which the industrial automation system operates, or a selected subset of the content of the one or more custom models.

15. The method of claim 10, further comprising, in response to determining, based on analysis of the natural language request, that additional information will allow the system to formulate the natural language response such that the natural language response has a probability of satisfying the natural language request that exceeds a threshold:
generating, by the system, a natural language prompt for the additional information;
rendering, by the system, the natural language prompt via the chat interface; and
formulating, by the system, the natural language response based on analysis of the natural language request, the content of the one or more custom models, and the additional information.

16. The method of claim 10, wherein the natural language request describes at least one of the alarm condition, a machine or device of the industrial automation system that experiences the alarm condition, or a type of information about the alarm condition to be provided by the natural language response.

17. The method of claim 10, wherein the type of information about the alarm condition is at least one of a recommendation for resolving the alarm condition, a historical frequency at which the alarm condition occurs, indications of machines that are affected by the alarm condition, or an average machine downtime caused by the alarm condition.

18. The method of claim 10, wherein the alarm condition is at least one of a value of a key performance indicator of the industrial automation system exceeding a defined high limit, the value of the key performance indicator moving below a defined low limit, a memory usage alarm for an industrial device, a machine downtime condition, an abnormal status indicator, or a device communication error.

19. A non-transitory computer-readable medium having stored thereon instructions that, in response to execution, cause a system comprising a processor to perform operations, the operations comprising:
storing alarm data generated by devices of an industrial automation system in a cloud-based alarm repository, wherein the alarm data represents active and historical alarm conditions experienced by the industrial automation system;
rendering a chat interface on a client device;
receiving, via interaction with the chat interface, a natural language request for assistance with an alarm condition of the active and historical alarm conditions;
in response to the receiving of the natural language request, generating a natural language response describing a recommendation for addressing the alarm condition based on analysis of the natural language request, the alarm data, and content of one or more custom models trained with training data; and
rendering the natural language response via the chat interface on the client device.

20. The non-transitory computer-readable medium of claim 19, further comprising storing resolution data describing actions performed by plant personnel to resolve one or more of the historical alarm conditions,
wherein the generating of the natural language response comprises generating the natural language response further based on analysis of the resolution information.
